(19) United States
(12) Patent Application Publication
(10) Pub. No.: US 2002/0161656 A1
(43) Pub. Date: Oct. 31, 2002

(54) METHOD AND SYSTEM FOR IDENTIFYING PRODUCT SPECIFICATIONS

(75) Inventor: JANET W. MONGILIO, EVANSVILLE, IN (US)

Correspondence Address: CANTOR COLBURN, LLP, 55 GRIFFIN ROAD SOUTH, BLOOMFIELD, CT, 06002

(73) Assignee: CANTOR COLBURN LLP

(21) Appl. No.: 09/439,598

(22) Filed: Nov. 12, 1999

(51) Int. Cl. G06F 17/60

(52) U.S. Cl. 705/26

(57) ABSTRACT

An exemplary embodiment of the invention is a method for identifying product specifications between a purchaser system and a seller system connected over a network. The method includes using the purchaser system to identify a product specification. The seller system receives the product specification and automatically computes a product cost in response to the product specification. The product cost is then provided to the purchaser system. This allows the purchaser to determine the effect of product specifications on cost.

### BACKGROUND OF THE INVENTION

The invention relates generally to a computer-implemented method and system for identifying product specifications. Purchasers often provide product specifications to a seller so that the seller can obtain and/or manufacture the product to comply with the product specifications. An exemplary product specification is color variance of a product such as plastic. The purchaser provides the seller with acceptable limits on color variance so the seller can manufacture the product having a specific color and within the acceptable color variance limits.

Currently, there is no efficient system for a purchaser to notify a seller of product specifications. The purchaser typically provides product specifications upon submitting an initial order to a seller. Changes in product specifications may be difficult to effect because of failures in communication between sales personnel and manufacturing personnel. In addition, a purchaser has little or no information concerning how changes in product specifications effect cost of the product. Accordingly, there is a need in the art for a method and system for identifying product specifications.

### BRIEF SUMMARY OF THE INVENTION

An exemplary embodiment of the invention is a method for identifying product specifications between a purchaser system and a seller system connected over a network. The method includes using the purchaser system to identify a product specification. The seller system receives the product specification and automatically computes a product cost in response to the product specification. The product cost is then provided to the purchaser system. This allows the purchaser to determine the effect of product specifications on cost.

### BRIEF DESCRIPTION OF THE DRAWINGS

FIG. 1 is a block diagram of a system for identifying product specifications;

FIG. 2 is a flowchart of a method for identifying product specifications;

FIG. 3 is an exemplary user interface for selecting a specification scope; and,

FIG. 4 is an exemplary user interface for entering product specifications.

### DETAILED DESCRIPTION OF THE INVENTION

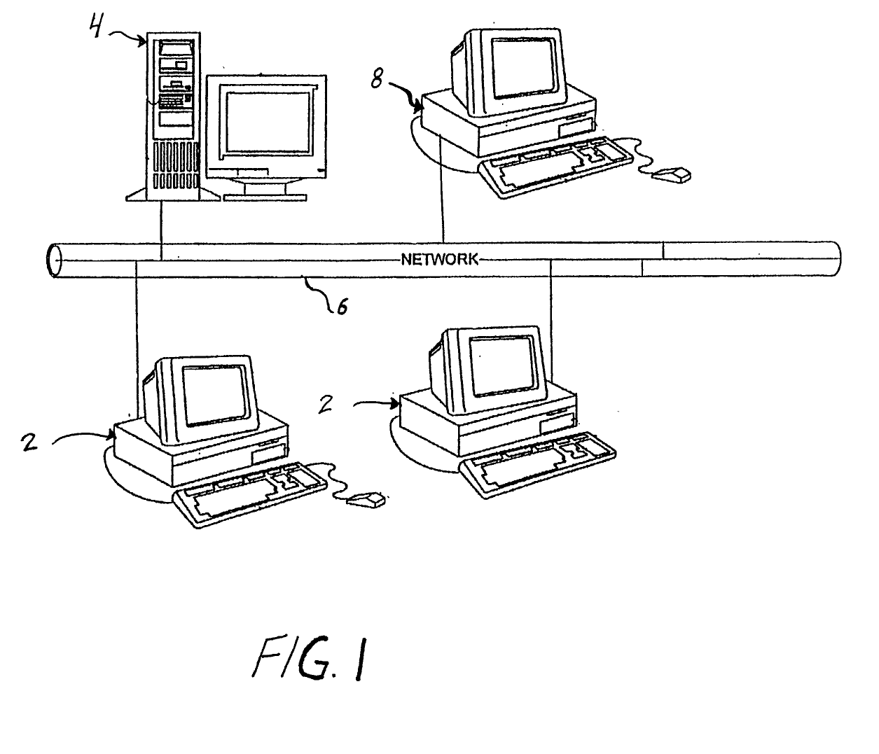

An exemplary embodiment of the invention is a method and system for identifying product specifications. FIG. 1 is a block diagram of a system in an exemplary embodiment of the invention. As shown in FIG. 1, the system includes a plurality of purchaser systems 2 coupled to a seller system 4 over a network 6. The network 6 may be any type of known network including a local area network (LAN), wide area network (WAN), global network (e.g., Internet), etc. The seller system 4 may be implemented using a general-purpose computer executing a computer program for carrying out the process described herein. The seller system 4 acts as a server for the multiple purchaser systems 2 which act as clients. Similarly, purchaser systems 2 may be implemented using general-purpose computers executing a computer program for carrying out the process described herein. Purchaser systems 2 access the seller system 4 over the network 6 using known user interface applications (e.g., web browsers). Also coupled to the network 6 is a manufacturing system 8. The manufacturing system 8 may be implemented using a general-purpose computer executing a computer program for carrying out the process described herein. Manufacturing system 8 accesses the seller system 4 over the network 6 using known user interface applications (e.g., web browsers).

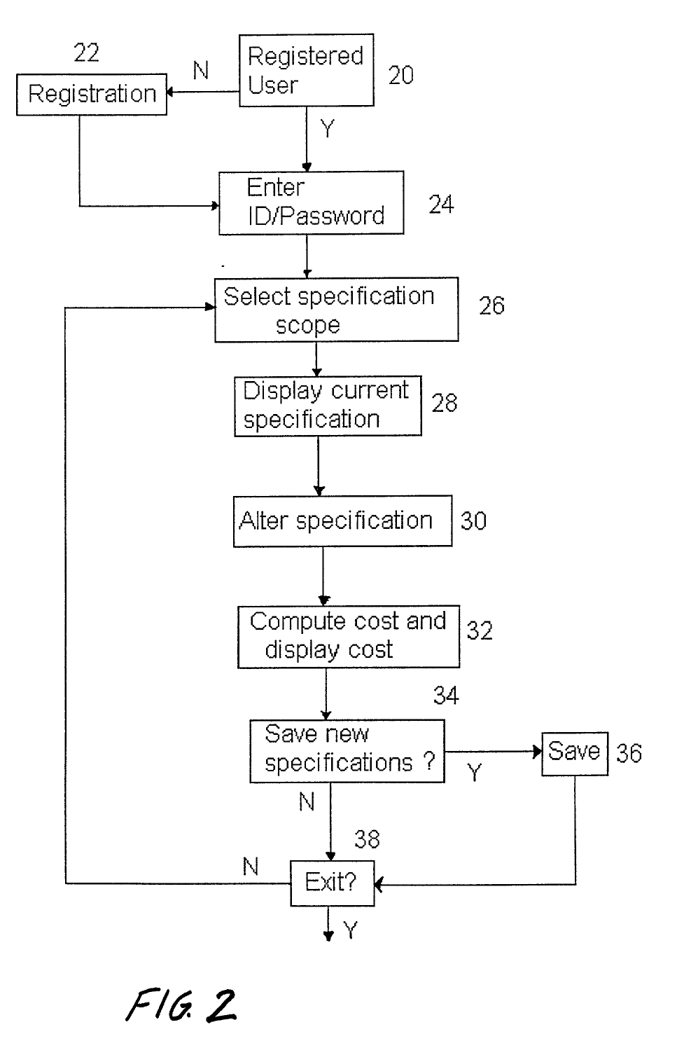

The system of FIG. 1 allows purchasers to review and alter product specifications stored at the seller system 4 remotely over network 6. The product specifications can also be accessed by the manufacturing system 8 over network 6 to ensure that the product is manufactured based on the current product specifications. FIG. 2 is a flowchart of an exemplary process implemented using the system of FIG. 1. The process is initiated when a purchaser system 2 contacts the seller system 4. The purchaser system 2 can contact seller system 4 in a variety of ways including use of a web browser application that directs the purchaser system to a web site implemented through seller system 4.

Once the purchaser system 2 contacts the seller system 4, the seller system 4 asks whether the purchaser is a registered purchaser at step 20. Unregistered purchasers are then prompted to register at step 22 by creating a purchaser identification and password, contact information, such as mailing address and email address. This collection of information is referred to as a purchaser profile and is stored on the seller system 4 or a memory device accessible by the seller system 4. Registered purchasers provide their user identification and password at step 24 to gain access to the seller system 4.

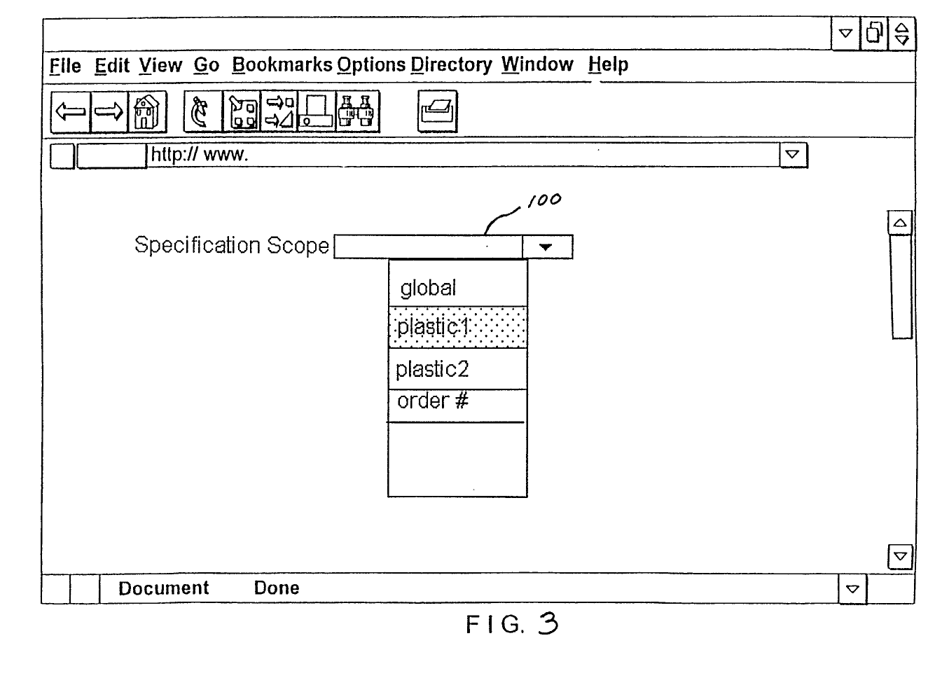

Once a valid purchaser identification and password have been entered, flow proceeds to step 26 where the purchaser can select a scope for a product specification. The scope of a product specification may range from global (i.e., all products the purchaser receives must meet the specification) to a specific product (e.g., Lexan™ brand plastics must meet the specification) to a specific order. FIG. 3 depicts an exemplary user interface through which the purchaser can identify the scope for the specification. FIG. 3 depicts a specification scope field 100 which may be completed by the purchaser through a pull-down menu or other known techniques.

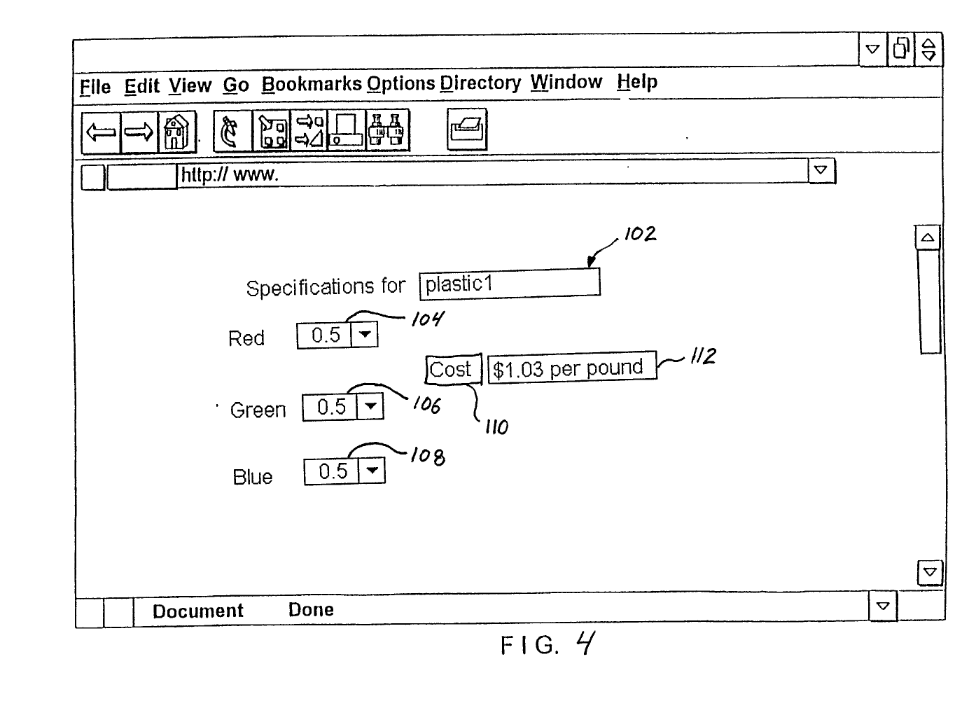

Once the purchaser has identified the specification scope, flow proceeds to step 28 where the current specification for the selected scope is displayed. FIG. 4 depicts an exemplary user interface in which the specification scope is presented to the user at specification scope identifier 102 and the current specification is provided in one or more specification fields. In step 30, the purchaser can alter the product specifications. In the example shown in FIG. 4, the purchaser can edit color specifications by entering acceptable color variance in a red field 104, green field 106 and blue field 108. As shown in FIG. 4, the purchaser has specified that for orders of plasticl (e.g., Lexan™ brand plastic) each of the red, green and blue components be within 0.5 units of the color values ordered by the purchaser. The specification may also be represented as a percentage (e.g., within 1% of ordered value). A lower specification limit may automatically be imposed on the product specifications. For example, the purchaser cannot enter zero for a product specification because some variance is almost always present in manufacturing processes. Other product specifications may be entered by the purchaser and the invention is not limited to color specifications. In addition, specifications other than acceptable variance can be entered. For example, the purchaser can enter limits such as maximum value and/or minimum value. In general, the product specification can be considered a constraint on product values.

Once the color specifications are edited, flow proceeds to step 32 where the seller system computes the cost of the product in response to the product specification entered by the purchaser. The purchaser can request an updated cost computation by selecting cost icon 110. The seller system computes the cost for the product and presents the cost in a cost field 112. The cost may be determined from the product specification for the specified product scope in a number of ways. The seller system 4 may use an equation to derive the product cost. Generally, the smaller the specified variance in the product specification, the more costly it is to manufacture the product. An exemplary equation is

cost=standard cost*(standard variance/specified variance)ˆ 2

where standard cost is based on existing manufacturing processes and tolerances, standard variance is the existing manufacturing variance and specified variance is a product specification entered by the purchaser. The cost may also be determined based on product capability analysis. The product capability can be represented as

Cp=abs(USL−mean)/3σ

where Cp is a capability, USL is an upper specified limit for a value (e.g., a maximum entered by a purchaser), mean is the average for the value and C is the standard deviation of the value. A Z score can be determined as

Z=3Cp.

Assuming a normal distribution, the Z score indicates the probability that the value will meet the upper specified limit. A process yield is determined by 100 times the probability derived from the Z score. Process yield can then be used to compute cost as follows

cost=mincost/process yield

where mincost is a cost value based on 100% yield. A lower process yield will result in a higher cost to the purchaser.

Alternatively, the cost can be determined using a look up table in which the product specifications are used to retrieve predetermined cost values. The predetermined cost values may be based on empirical data including interpolated and extrapolated empirical data.

The cost computation is based on the specification scope defined by the purchaser. If the purchaser specifies one product (e.g., Lexan™ brand plastic), the seller system 4 determines the cost based on equations and/or data relevant to this product. If the specification scope is global (meaning all products must meet the specification) the seller system 4 computes the cost for each product and then combines these costs (e.g., by averaging) to determine the global cost.

Once the cost has been computed at step 32, flow proceeds to step 34 in which the purchaser is queried whether the purchaser wants to save the new specifications. If the purchaser responds yes, then flow proceeds to step 36 where the new specifications are saved. After saving the new specifications, or if the purchaser responds No at step 34, flow proceeds to step 38 where the purchaser can exit or return to step 26.

The purchaser specifications may be saved at seller system 4 or at a memory device accessible by seller system 4. Upon manufacturing a product for the purchaser, the manufacturing system 8 can access the saved product specifications to ensure that the product is made to the proper specifications. For example, if the seller is manufacturing Lexan™ brand plastic for a purchaser, the manufacturing system 8 accesses the purchaser's product specifications for Lexan™ brand plastic, either through seller system 4 or by accessing a memory device over network 6. The manufacturing system 8 may be under the control of a manufacturing supervisor who schedules production and can access the relevant product specifications prior to scheduling production runs.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A method for identifying product specifications between a purchaser system and a seller system connected over a network, the method comprising:
using the purchaser system to identify a product specification;
receiving said product specification at the seller system;
automatically computing a product cost in response to said product specification; and
providing said product cost to the purchaser system.

2. The method of claim 1 further comprising:
selecting a specification scope defining products to which said product specification applies.

3. The method of claim 2 wherein:
said specification scope defines all products ordered by the purchaser.

4. The method of claim 2 wherein:
said specification scope defines one product ordered by the purchaser.

5. The method of claim 1 further comprising:
imposing a limit on said product specification.

6. The method of claim 1 further comprising:
providing said product specification to a manufacturing system, said product specification being used in manufacturing the product.

7. The method of claim 2 further comprising:
saving said specification scope and said product specification in a memory device accessible by the seller system.

8. The method of claim 1 wherein:
the network is the Internet.

9. The method of claim 1 wherein:
said product specification defines a constraint on a product value.

10. The method of claim 9 wherein:
said product specification defines an allowable variance in the product value.

11. The method of claim 9 wherein:
said product specification defines a limit on the product value.

12. A system for identifying product specifications, the system comprising:
a purchaser system for identifying a product specification;
a network coupled to said purchaser system;
a seller system coupled to said network, said seller system receiving said product specification;
said seller system automatically computing a product cost in response to said product specification and providing said product cost to the purchaser system.

13. The system of claim 12 wherein:
said purchasing system provides a specification scope defining products to which said product specification applies.

14. The system of claim 13 wherein:
said specification scope defines all products ordered by a purchaser.

15. The system of claim 13 wherein:
said specification scope defines one product ordered by a purchaser.

16. The system of claim 12 wherein:
said seller system imposes a limit on said product specification.

17. The system of claim 12 further comprising:
a manufacturing system for accessing said product specification for use in manufacturing the product.

18. The system of claim 13 further comprising:
a memory device for saving said specification scope and said product specification, said memory device accessible by the seller system.

19. The system of claim 12 wherein:
the network is the Internet.

20. The system of claim 12 wherein:
said product specification defines a constraint on a product value.

21. The system of claim 20 wherein:
said product specification defines an allowable variance in the product value.

22. The system of claim 20 wherein:
said product specification defines a limit on the product value.

23. A storage medium encoded with machine-readable computer program code for identifying product specifications between a purchaser system and a seller system connected over a network, the storage medium including instructions for causing a computer serving as the seller system to implement a method comprising:
requesting the purchaser system to identify a product specification;
receiving said product specification at the seller system;
automatically computing a product cost in response to said product specification; and
providing said product cost to the purchaser system.

24. The storage medium of claim 23 further comprising instructions for causing the computer serving as the seller system to implement:
requesting a specification scope defining products to which said product specification applies.

25. The storage medium of claim 24 wherein:
said specification scope defines all products ordered by the purchaser.

26. The storage medium of claim 24 wherein:
said specification scope defines one product ordered by the purchaser.

27. The storage medium of claim 23 further comprising instructions for causing the computer serving as the seller system to implement:
imposing a limit on said product specification.

28. The storage medium of claim 23 further comprising instructions for causing the computer serving as the seller system to implement:
providing said product specification to a manufacturing system, said product specification being used in manufacturing the product.

29. The storage medium of claim 24 further comprising instructions for causing the computer serving as the seller system to implement:
saving said specification scope and said product specification in a memory device accessible by the seller system.

30. The storage medium of claim 23 wherein:
the network is the Internet.

31. The storage medium of claim 23 wherein:
said product specification defines a constraint on a product value.

32. The storage medium of claim 31 wherein:
said product specification defines an allowable variance in the product value.

33. The storage medium of claim 31 wherein:
said product specification defines a limit on the product value.
